(19) United States
(12) Patent Application Publication
(10) Pub. No.: US 2002/0115422 A1
(43) Pub. Date: Aug. 22, 2002

(54) System and method for a voice controlled weather station

(76) Inventor: Bruce R. Robinson, Cedar Crest, NM (US)

Correspondence Address: Edward J. Kondracki, MILES & STOCKBRIDGE P.C., Suite 500, 1751 Pinnacle Drive, McLean, VA, 22102-3833, US

(21) Appl. No.: 09/991,879

(22) Filed: Nov. 26, 2001

Related U.S. Application Data
(60) Provisional application No. 60/268,874, filed on Feb. 16, 2001.

(51) Int. Cl. H04Q 7/20

(52) U.S. Cl. 455/403; 455/517; 455/563

(57) ABSTRACT

A meteorological information system usable by aircraft pilots and others is activated by voice or tone commands from the user. A radio frequency transmitter/receiver unit configured to detect predetermined voice or tone commands transmitted by the user over a designated frequency is connected to a voice recognition system, which converts the received voice commands into computer commands that elicit pertinent stored meteorological data and location data related to an airport and/or its runways, processes the data into a form usable to the requester, and causes the result to be transmitted in synthesized voice format to the requestor.

This application discloses subject matter which was disclosed in U.S. Provisional Patent Application Serial No. 60/268,874, filed Feb. 16, 2001. This application claims the benefit of that filing date for all common subject matter.

### BACKGROUND OF THE INVENTION

1. Field of the Invention

The present invention relates to systems for providing meteorological information, and more particularly, to a system and method for supplying weather information to aircraft pilots, and more specifically, to a computer system that recognizes audio commands transmitted from a remote location which initiate delivery of site-specific weather information composed in a synthesized voice format.

2. Description of Related Art

Historically, pilots of private aircraft have relied on a windsock viewed from 1,000 to 1,500 feet while flying over a private airfield or heliport to determine wind speed and direction. More recently, in airports having tower operations or a fixed base operator, aircraft pilots have used radio voice communication with operators at the airport to obtain important weather information, including wind speed and direction. Within the last fifteen years at public airports in the United States, the federal government has installed automated weather observation systems (AWOS). The AWOS system measures airport weather conditions, and then broadcasts continuously updated voice recordings to transmit the information to aircraft near the airport on an allocated frequency. This system was later upgraded to a more sophisticated Automated Surface Observing System (ASOS) at the 1,000 largest public U.S. airports. The ASOS system provides a variety of weather information via continuous voice radio communication to aircraft in the vicinity of the airport on an allocated frequency. Such automated systems can cost anywhere from $30,000 to $150,000 per airport. A disadvantage of both AWOS and ASOS is that these systems require aircraft pilots to process a continuous stream of audible (voice message) information from a radio receiver in the aircraft while simultaneously attending to aircraft operations. As described below, the processing of this audible information often includes performance of calculations on, and analysis of, the information.

There are about 5500 public airports in the United States that should have automatic weather systems provided by the federal and local government to facilitate air safety for public air transportation. However, there are an additional 13,200 private airstrips, heliports, and seaplane bases that, due to cost constraints, will not be instrumented via these federal programs. There is a need, therefore, for a low cost, reliable, alternative system that will serve these non-instrumented locations.

One solution that has been advanced is a system operating on common traffic advisory frequencies, which relies on a specific number of microphone key clicks to activate transmission of weather information over common traffic advisory frequencies. Selection of weather site-specific data using this approach is limited by the complexity of the keystroke codes required for the ground-based system to recognize specific commands from the aircraft pilot and interference from adjacent airport radios.

U.S. Pat. No. 6,154,143 describes a system including a ground based weather station, typically located near an airport runway, that provides raw meteorological data to a digital FM transmitter system, which periodically broadcasts updated data for reception by a portable receiver-calculator unit located in an aircraft that is taking off or operating in the vicinity of the airport. The raw data is then converted to useable information for the aircraft pilot. The disadvantage of such a system is that it requires that the pilot purchase a specialized handheld receiver, making it available to a limited number of users that can afford to purchase the receiver.

With the exception of the portable digital weather system, no crosswind and headwind information selected by the aircraft operator is available from any of the voice transmissions of weather data except as transmitted in the blind and therefore, tying up voice transmission frequencies needed for related aircraft operation.

Meteorological information is important, of course, to pilots of small aircraft. Such weather factors as crosswind and headwind speed and direction, wind gust speed and direction, and dew point temperature, inform the pilot's judgment, particularly during takeoff and landing. The pilot operating out of a small private airport may, at best, obtain some basic absolute wind speed and direction, barometric pressure, and temperature information from automated audio broadcasts from the facility, or from live audio radio communication from the fixed-base facility operator. At numerous remote airstrips, the pilot must still rely upon a wind sock, or upon regional weather reports. Still, even voice communications from a fixed base operator or automated broadcast leave the pilot with the task of referring to printed graphs, charts, and nomographs, and operating hand-held standard electronic calculators, or performing handwritten calculations, to determine, from raw audio data, vital information such as cross wind and headwind speeds and directions, dew point temperature, and the like.

Wind information is needed both as an average over a period of time and at peak level or gust conditions in order to assure safe operation within the limitations of the aircraft. The pilot uses the results from the processing of meteorological information to evaluate whether a takeoff or landing can be safely performed in the particular type of aircraft being used, under the given weather conditions, on a particular runway.

Performing such evaluations correctly is important, and desirably, such calculations should not be undertaken simultaneously with flying the aircraft and listening to the radio. Even when an assistant is available to perform the calculations, the opportunity for human error suggests the desirability of an apparatus which simplifies the task and minimizes error.

A need remains, therefore, for a low cost system for small airports, private airports, seaplane bases and heliports that minimizes the broadcast frequency allocations and minimizes common traffic frequency usage, but that allows site-specific information to be recovered, as needed, by aircraft operators. More specifically, a system and apparatus is needed for receiving calculated information such as crosswind and headwind speed and direction, and the like, which have been pre-calculated from raw meteorological data endemic to a specific airport, without the pilot having to be distracted while operating the aircraft itself.

### SUMMARY OF THE INVENTION

The present invention is directed to a method and system for assisting aircraft pilots and others in easily and rapidly obtaining processed meteorological information particular to a specific site, as requested by voice commands, while minimizing the transmission time on the common traffic advisory frequency. The processed information includes, for example, crosswind and headwind speed and direction, wind gust speed and direction, and dew point temperature, which have been pre-calculated from basic absolute wind speed and direction, barometric pressure, and temperature information endemic to the specific location. The information can be used for making judgments in any field where meteorological data is critical, for example, in boating, golf, scientific investigation such as volcanology, and industrial use such as hazardous material plume monitoring. However, for ease of description, and not by way of limitation, the present invention will be herein described in terms of application to aircraft operations.

In addition to meteorological information transmitted to the aircraft pilot, other data including landing strip identification, latitude, longitude, altitude and airport status can be conveyed. All of this data, generally referred to as “meteorological and location data”, is provided in a customized fashion, according to the specific audio commands transmitted by the aircraft pilot.

According to the present invention, an apparatus is provided that includes at least one weather data collection station configured for automatically collecting and electronically communicating meteorological and location data, and at least one weather data server system configured for automatically receiving and processing the communicated data and subsequently automatically broadcasting the processed data in synthesized voice format in response to a command signal, such as, for example, a predetermined voice command or signal tone or combination of tones.

The weather data server system can be configured to be in communication with one or more weather data collection stations, and an individual weather data collection station can be configured to communicate with one or more weather data servers, and separate server systems can be inter-connected for sharing data.

Alternatively, the voice or tone controlled weather station of the present invention can be configured such that all components, including the weather data server system and the weather data collection station, are physically consolidated into a single, unitary arrangement.

The weather data server system includes a weather data server system computer arranged to be in communication with a digital data input system and an audio transmitter/receiver system. The digital data input system is configured to receive the raw meteorological and location data communicated from one or more weather data collection stations, and can be, for example, a digital receiver, a digital data port connected to a data communications cable, or the like. The received digital data is communicated to the weather data server system computer for processing and storage.

The audio transmitter/receiver system, also connected to the weather data server system computer, is arranged to receive the command signal unique to the selected weather station location and communicate the signal to the weather data processing computer, which, responsive to the command signal, initiates a sequence of steps including processing of selected meteorological and location data, formulation of a report therefrom, conversion of the report into synthesized voice data, and transmission of the voice data report over the transmitter/receiver system. The specific command signal received by the system determines, optionally, the content, extent, or format of the synthesized voice report. Any audible command signal suitable for activating the weather data server is envisioned, such as, for example audio tones, voice, or pre-recorded voice commands. An example of the use of audio tones is a sequence or combination of tones generated by a telephone-type keypad. A system of this type could advantageously be used as a backup to a voice command system, for use when voice transmissions are not being sent clearly, or in the event that the receiver is not able to accurately interpret the voice command.

The present invention is further directed to a method for operating a voice controlled weather station that includes the steps of collecting and storing meteorological data and location data, calculating processed data useful to an aircraft pilot from a selected set of the stored meteorological data and location data, converting the processed data into voice synthesized data, and transmitting the voice synthesized data responsive to a command signal, wherein the selected set of stored meteorological data is determined by the command signal and the command signal is determined from a voice command.

### BRIEF DESCRIPTION OF THE DRAWINGS

The above and other features of the present invention and the attendant advantages will be readily apparent to those having ordinary skill in the art and the invention will be more easily understood from the following detailed description of the preferred embodiments of the present invention, taken in conjunction with the accompanying drawings.

FIG. 1 is a schematic diagram of a preferred embodiment of a system according to the present invention;

FIG. 2 is a flow diagram of the method of the present invention.

### DESCRIPTION OF THE PREFERRED EMBODIMENTS

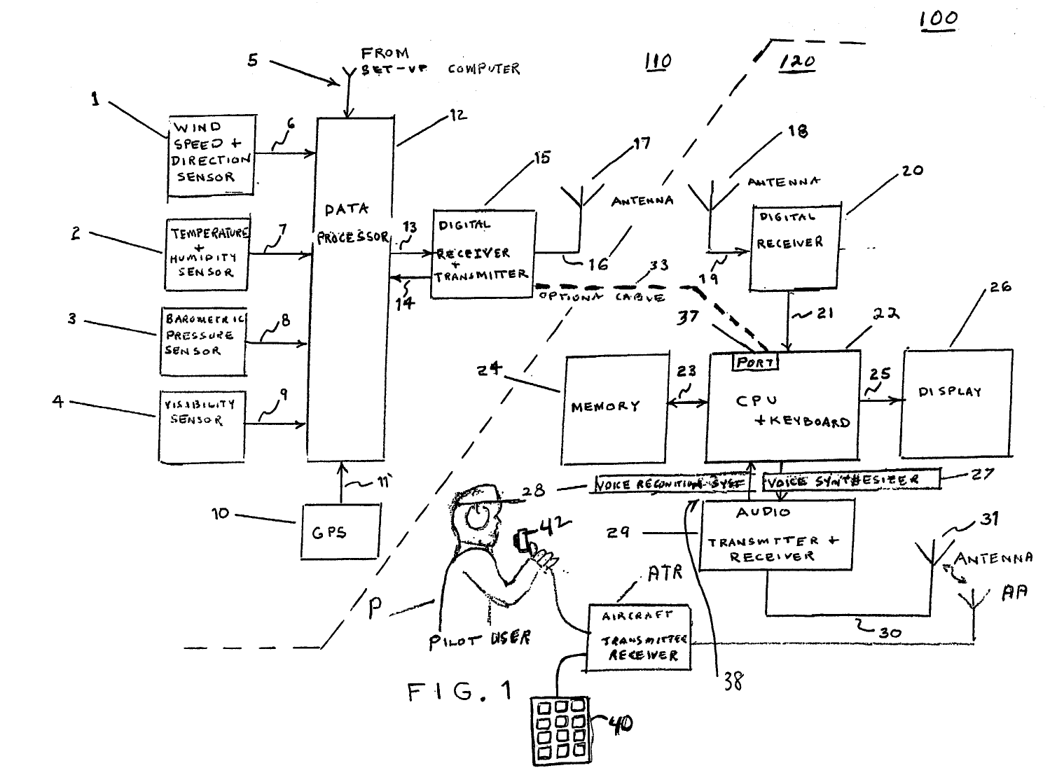

FIG. 1 is a schematic block diagram showing the voice controlled weather station 100 according to a preferred embodiment of the present invention. The weather station 100 includes two parts, a weather data collection station 110 and a weather data server system 120. Weather data collection station 110 typically is situated at a selected location at an airport, such as at a landing strip, and employs known technologies to automatically gather fundamental meteorological information for periodic transmission to weather data server system 120, which can be located the airport associated with the landing strip, or elsewhere. Weather data collection station 110 is located according to known practices, such as, for example, fixed to a building or to a pole, and typically is in a stationary but elevated position relative to the ground, as described in U.S. Pat. No. 6,154,143, hereby incorporated by reference in its entirety. Station 110 is provided with a source of electrical power including, for example, connection to the public utility grid or to a battery that is rechargeable by an electrically connected conventional solar energy collector panel.

Weather data collection station 110 includes any preferred arrangement and configuration of meteorological sensors, such as, for example, a wind speed and direction sensor 1, a temperature and humidity sensor 2, a barometric pressure sensor 3, and a visibility sensor 4, all configured to communicate measured meteorological data to a data processor 12 over data paths 6-9, respectively. Processor 12 is configured to receive set-up instructions through input 5. A global positioning satellite (GPS) sensor 10 configured to provide GPS data including latitude, longitude, and altitude information to data processor 12, wherein the altitude information is used to correct barometric pressure for altitude, is connected to processor 12 over data path 11. Optionally this data may be programmed in the memory of processor 12. Real-time data regarding wind speed and direction, temperature, humidity, barometric pressure and visibility provided by sensors 1-4, together with the GPS data, are provided to a digital radio transmitter/receiver 15, which may, for example, be a digital FM radio transmitter/receiver, over data connection 13 for communication to at least one weather data server system 120. Optionally, a separate data connection 14 is available to communicate control signals originating from any suitable source, and received by digital transmitter/receiver 15, to data processor 12. transmitter/receiver 15 is connected to an antenna 17 by way of data path 16.

In addition to meteorological information collected by the sensors, other data including landing strip identification, together with GPS data including latitude, longitude, and altitude information, as well as airport status can be collected and conveyed to data processor 12. This entire set of data is herein generally referred to as “meteorological and location data”.

The sensed meteorological and location data is periodically and asynchronously transmitted remotely from digital transmitter/receiver 15, via antenna 17, to antenna 18 of weather data server system 120 for storage and processing. This can be accomplished by any known suitable method, for example, by a timing circuit of known construction whereby transmission of updated collected meteorological data occurs at periodic intervals, for example every ten seconds. Alternatively, the system can be set up such that digital transmitter/receiver 15 “listens” for a clear channel before transmitting a short duration pulse of the data, permitting multiple station data transmissions on the same frequency.

Alternatively, data processor 12 and digital transmitter/receiver 15 may be connected to weather data server system 120 by a digital data communication cable 33 configured to operate under any known digital data transmission protocol for communication of the sensed meteorological data and optional control signals.

Still referring to FIG. 1, weather data server system 120 includes a data processing computer 22 in communication with a digital data input section of system 120 and an audio transmitter/receiver section 29 of system 120. The audio transmitter/receiver section 29 may operate in the AM frequency bandwidth, for example. The digital data input system 20 is configured to receive the raw meteorological and location data communicated from one or more weather data collection stations 110, as described above, and can be, for example, a digital receiver 20 electrically connected to antenna 18 by data path 19, and connected to processing computer 22 by data path 21. Alternatively, the raw meteorological and location data may be communicated over data communications cable 33, through a digital data port 37, to computer 22.

Data processing computer 22 is further connected by data path 23 to memory 24, by data path 25 to display 26, and by data path 38 to audio transmitter/receiver 29, which is, in turn, connected by data path 30 to aircraft communications antenna 31. Computer 22 is configured to automatically update memory 24 with the received raw meteorological and location data.

Audio transmitter/receiver 29 is configured to communicate with a remotely located user P, such as an aircraft pilot P, by way of an aircraft audio transmitter/receiver ATR connected to an aircraft antenna AA.

Data processing computer 22 is further connected to, or optionally, incorporates, a voice synthesizer system 27 and a voice/tone recognition system 28. Synthesizer system 27 and recognition system 28 are physically and functionally interconnected between programs operating in data processing computer 22 and audio transmitter/receiver 29, such that voice commands originating from aircraft pilot user P and received through aircraft communications antenna 31, connected to audio transmitter/receiver 29, are processed by voice/tone recognition system 28, which responsively outputs data command signals to programs operating in computer 22. Optionally, the voice recognition system may comprise voice recognition software stored in computer 22. The programs are thereby caused to retrieve stored meteorological and location data, process that data into a form useful to aircraft pilot user P, and output the resulting processed data to voice synthesizer system 27 for conversion into user-understandable language. The outputted synthesized voice data is then communicated to audio transmitter/receiver 29, which automatically transmits the data in an understandable audio signal to aircraft pilot user P.

The specific voice commands originating from aircraft pilot user P may preferably be selected from a set of pre-defined words, or combination of words or tones, and, after processing by the voice/tone recognition system 28, each uniquely communicates to the programs in data processing computer 22 the content, extent, or format of the synthesized voice report that is being requested by, and will form the response to, the aircraft pilot user's inquiry.

For example, the system of the present invention may be arranged to use a unique key word, such as, for example, “DigiWx” (a registered trademark of the Belfort Instrument Company), to activate the voice recognition system. The aircraft pilot user could request general weather information from a small airport located at, for example, Easton, Md., by tuning the ATR to the common traffic advisory frequency at the airport on his aircraft transmitter/receiver, and stating (i.e., broadcasting): “DigiWx Easton Weather”. The weather data server system 120 would receive and recognize the command as a request for general weather information at the Easton Airport, and initiate a broadcast reply: “Easton Weather: Wind 340 at 15, Gusts 360 at 20, Temperature 30, Dewpoint 50, Altimeter 30.11.”

If the aircraft pilot is concerned about cross winds for the selected runway, the pilot could state: “DigiWx Easton Runway 02.” The system would recognize the voice command as requesting wind information on the runway with a heading of 20 degrees and reply: “Easton Runway 02: Headwind 11, Crosswind 10, Gust Headwind 15, Gust cross wind 13”.

This information is critical to takeoff and landing decisions for a particular runway, but, because it is needed by the pilot only if the pilot believes that wind conditions are approaching the limitations of the aircraft in use, it, like all weather information provided by the system of the present invention, is provided only on request, thereby minimizing transmission time on the common traffic advisory frequency so as not to interfere with aircraft usage of this frequency.

When runway information is specified in the request for data, the programs resident in weather data server system 120 may be programmed to calculate the wind components for the specified runway and include that information with the data to be sent to voice synthesizer 27. Additional pre-programmed information can be included, such as, for example, site-specific physical data about the runway (length, altitude, hazards, and the like). Other aspects of the report can be either pre-set or dynamically determined by pre-determined definitions of the voice commands.

Weather data server system 120 can be configured to be in communication with one or more weather data collection stations 110, and an individual weather data collection station 110 can be configured to communicate with one or more weather data servers 120. Separate server systems 120 can be inter-connected for sharing data.

Alternatively, voice controlled weather station 100 can be configured such that all components, including weather data server system 120 and weather data collection station 110, are physically consolidated into a single, unitary arrangement in which all data paths, except for audio transmitter/receiver 29, are direct connections. In such an embodiment, data processor 12 and data processing computer 22 can be the same, or optionally, remain physically separate.

FIG. 1 also illustrates an input device 40 which provides, in addition to the ability to use voice commands to initiate the process of transmitting meteorological and location data, the ability to use a sequence or combination of tones in order to initiate the process. The input device, as illustrated, is a keypad 40 provided in the aircraft in a position accessible to the pilot or another crew member. The keypad is preferably a numeric keypad, of the type used in touch-tone telephone equipment, primarily from the standpoint that such keypads are readily commercially available and are familiar to most potential users. The keypad may be directly connected to audio AM transmitter/receiver 29, or may have an audio output 43 detectable by microphone 42. Alternatively, the tone input device 40 may be formed integrally with microphone 42.

When such a keypad device 40 is made available to pilots, the CPU 22 or voice/tone recognition system 28 is preferably also programmed to identify the type of data requested, and for which airport location, on the basis of a unique combination of tones generated by the keypad. It is envisioned that a three-tone combination will provide a sufficiently large number of permutations that airports and specific data requested can be uniquely identified, while also not overloading the potential user's ability to memorize codes or combinations used to obtain data from certain commonly visited airports, and while minimizing the amount of concentration required to input the desired combination of tones.

While a keypad input device 40 could be used in lieu of a voice input device, it is seen as being principally used as a backup or alternate input device to the microphone or speaker 42 into which the pilot or crew member speaks voice commands. The voice command system is believed to be the least obtrusive and least distracting to the pilot or crew member, which is an important safety feature. It is, however, recognized that certain conditions could be present which would adversely affect the ability to use the voice command input, and the provision of the keypad input device 40 would provide an alternative means of transmitting a request for data on a particular airport and, if desired, a particular runway. For example, it may be the case that a pilot has a speech impediment which would cause the voice recognition system 28 to inaccurately process and convert the voice command. Alternatively, the voice/tone recognition system 28 could be malfunctioning such that voice command conversion is affected, but not signals in the form of tones. In either of these situations, or other situations, the provision of the keypad yields an improvement in reliability and availability of the entire system.

The scheme of tone combinations can take on many forms, as will be readily apparent from the description herein. A currently preferred scheme is that unique three-tone combinations will be assigned to each airport in a particular region, possibly defined by a region in which airports share a common frequency for this type of communication. It is further possible to have a three-tone combination for general weather information, along the lines of the “DigiWx Easton Weather” voice command discussed previously, and different three-tone combinations for information specific to each runway at a given airport, in a manner analogous to using the “DigiWx Easton Runway 02” voice command discussed previously.

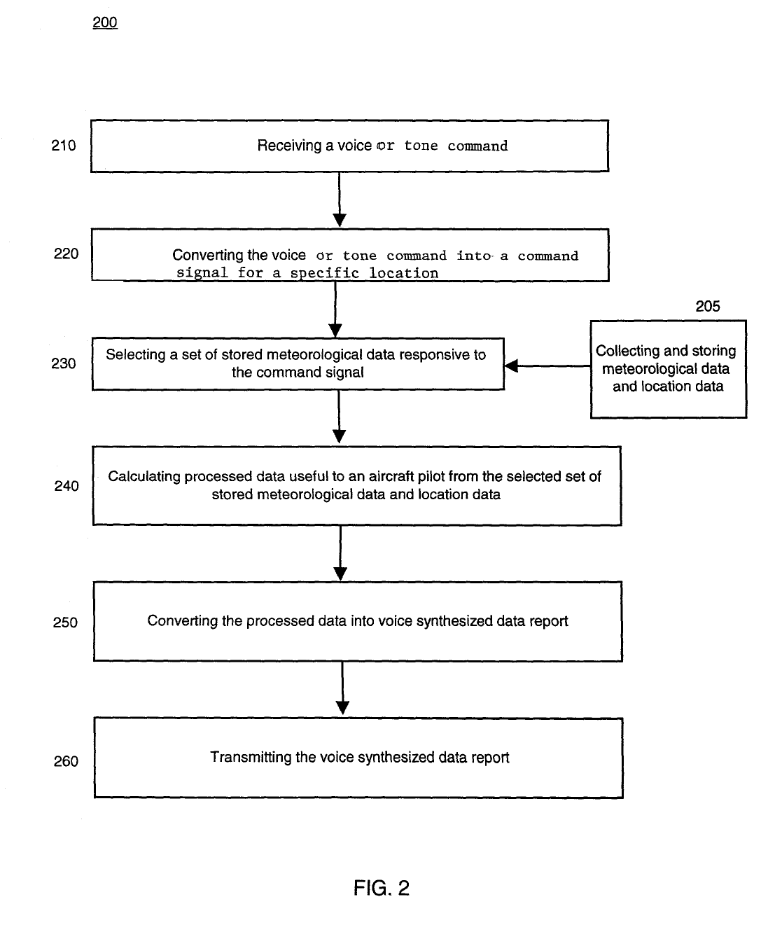

FIG. 2 is a flow diagram of a method 200 for operating a voice controlled weather station 100, in accordance with a preferred embodiment of the present invention. A first step, identified by reference numeral 210 involves receiving a voice command, which would be a command from a pilot, in the airfield implementation. The voice command is then converted into a command signal, as shown in step 220. The method then involves the step 230 of selecting a set of stored meteorological data responsive to the command signal. Step 240 involves calculating processed data useful to an aircraft pilot from the selected set of stored meteorological data and location data. The processed data is then converted 250 into a voice synthesized data report, and, in step 260, transmitted as by broadcasting over an audio AM transmitter, for reception by the originator of the voice command. An additional step 205, the collecting and storing of meteorological data and location data, is performed asynchronously with steps 210-260.

While this invention has been described in conjunction with specific embodiments thereof, it is evident that many alternative modifications and variations will be apparent to those skilled in the art. Accordingly, the preferred embodiments of the invention as set forth herein are intended to be illustrative, and not limiting. Various changes may be made without departing from the true spirit and scope of the invention as defined in the following claims.

What is claimed is:

1. A system for providing weather information to a pilot of an aircraft, comprising:
an audio receiver for receiving a command from a pilot of a requesting aircraft;
a voice/tone recognition system for interpreting commands received by said receiver to determine a location of interest,
a central processing unit for retrieving, from a memory associated with said central processing unit, weather information for said location of interest;
a voice synthesizer for converting said retrieved weather information into a voice-based weather data report; and
a transmitter for transmitting said voice-based data report to a requesting aircraft.

2. A system for providing weather information as recited in claim 1, wherein said voice/tone recognition system comprises voice/tone recognition software running in said central processing unit.

3. A system for providing weather information as recited in claim 1, wherein said voice/tone recognition system is external to said central processing unit, and is operatively coupled to said central processing unit.

4. A system for providing weather information as recited in claim 1, wherein said voice synthesizer comprises software running in said central processing unit.

5. A system for providing weather information as recited in claim 1, wherein said voice synthesizer is external to said central processing unit, and is operatively coupled to said central processing unit.

6. A system for providing weather information as recited in claim 1, further comprising at least one weather data collection sensor in communication with said central processing unit.

7. A system for providing weather information as recited in claim 6, further comprising a weather data processor for receiving an output from said at least one weather data collection sensor, said weather data processor in turn being in communication with said central processing unit.

8. A system for providing weather information as recited in claim 7, further comprising a plurality of weather data collection sensors, wherein said weather data processor receives an output from each of said plurality of weather data collection sensors.

9. A system for providing weather information as recited in claim 8, further comprising a transmitter/receiver constructed and arranged to receive data from said weather data processor, and to transmit said data to said central processing unit, wherein said weather data processor and said central processing unit are located remotely from each other.

10. A system for providing weather information as recited in claim 1, wherein said audio receiver and said central processing unit employ voice recognition means for converting a voice command to a command recognizable to said central processing unit as requesting specific data from memory.

11. A system for providing weather information as recited in claim 10, wherein said audio receiver and said central processing unit further employ tone frequency sensing means for converting a tone command to a command recognizable to said central processing unit as requesting specific data from memory.

12. A system for providing weather information as recited in claim 1, wherein said audio receiver and said central processing unit further employ tone frequency sensing means for converting a tone command to a command recognizable to said central processing unit as requesting specific data from memory.

13. A system for providing requested information to a requester, comprising:
an audio receiver for receiving a command from a requestor;
a voice/tone recognition system for interpreting commands received by said receiver and a central processing unit to determine a set of information of interest corresponding to a particular command received, and for retrieving, from a memory associated with said central processing unit, said set of information determined to be of interest;
a voice synthesizer for converting said retrieved set of information into a voice-based data report; and
a transmitter for transmitting said voice-based data report to the requestor.

14. A system for providing weather information as recited in claim 13, wherein said voice/tone recognition system comprises voice/tone recognition software running in said central processing unit.

15. A system for providing weather information as recited in claim 13, wherein said voice/tone recognition system is external to said central processing unit, and is operatively coupled to said central processing unit.

16. A system for providing weather information as recited in claim 13, wherein said voice synthesizer comprises software running in said central processing unit.

17. A system for providing weather information as recited in claim 13, wherein said voice synthesizer is external to said central processing unit, and is operatively coupled to said central processing unit.

18. A system for providing requested information as recited in claim 13, further comprising at least one data collection sensor in communication with said central processing unit.

19. A system for providing information as recited in claim 18, further comprising a data processor for receiving an output from said at least one data collection sensor, said data processor in turn being in communication with said central processing unit.

20. A system for providing information as recited in claim 19, further comprising a plurality of data collection sensors, wherein said data processor receives an output from each of said plurality of data collection sensors.

21. A system for providing information as recited in claim 20, further comprising a transmitter/receiver constructed and arranged to receive data from said data processor, and to transmit said data to said central processing unit, wherein said data processor and said central processing unit are located remotely from each other.

22. A system for providing information as recited in claim 13, wherein said audio receiver and said central processing unit employ voice recognition means for converting a voice command to a command recognizable to said central processing unit as requesting specific data from memory.

23. A system for providing information as recited in claim 22, wherein said audio receiver and said central processing unit further employ tone frequency sensing means for converting a tone command to a command recognizable to said central processing unit as requesting specific data from memory.

24. A system for providing information as recited in claim 13, wherein said audio receiver and said central processing unit further employ tone frequency sensing means for converting a tone command to a command recognizable to said central processing unit as requesting specific data from memory.

25. A method for providing weather information to a pilot of an aircraft comprising:
receiving a command from a pilot into a processing unit;
converting said command into a command signal;
selecting a set of stored meteorological data corresponding to said command signal;
processing said meteorological data into a form readily usable and understandable to a pilot;
converting said processed data into a voice-synthesized data report; and
transmitting said voice-synthesized data report to the pilot issuing said command.

26. A method for providing weather information as recited in claim 25, wherein said command received is a voice command.

27. A method of providing weather information as recited in claim 26, wherein said step of converting said command into a command signal comprises processing said voice command through a voice recognition system.

28. A method of providing weather information as recited in claim 25, wherein said command received is a series of audible tones.

29. A method of providing weather information as recited in claim 25, wherein said command received is a command selected from the group consisting of a voice command and a series of audible tones.

30. A method of providing weather information as recited in claim 25, further comprising periodically collecting and storing meteorological data and location data.

31. A method of providing weather information as recited in claim 30, wherein said collecting and storing of meteorological and location data is performed asynchronously with said receiving, converting, selecting, processing, converting, and transmitting steps.

32. A method for providing information to a requester, comprising:
receiving a command from a requester into a processing unit;
converting said command into a command signal;
selecting a set of stored data corresponding to said command signal;
processing said data into a form readily usable and understandable to a requestor;
converting said processed data into a voice-synthesized data report; and
transmitting said voice-synthesized data report to the requestor issuing said command.

33. A method for providing information as recited in claim 32, wherein said command received is a voice command.

34. A method of providing information as recited in claim 33, wherein said step of converting said command into a command signal comprises processing said voice command through a voice recognition system.

35. A method of providing information as recited in claim 32, wherein said command received is a series of audible tones.

36. A method of providing information as recited in claim 32, wherein said command received is a command selected from the group consisting of a voice command and a series of audible tones.

37. A method of providing information as recited in claim 32, further comprising periodically collecting and storing data.

38. A method of providing information as recited in claim 37, wherein said collecting and storing of data is performed asynchronously with said receiving, converting, selecting, processing, converting, and transmitting steps.
